(19) United States
(12) Patent Application Publication
(10) Pub. No.: US 2008/0019061 A1
(43) Pub. Date: Jan. 24, 2008

(54) Electrostatic 512kV rotator and oscillator propulsion system

(76) Inventors: David Joel Maker, Huntsville, AL (US); James M. Chenault, Huntsville, AL (US)

Correspondence Address: David J. Maker, 7807 Hilton Dr., Huntsville, AL, 35802, US

(21) Appl. No.: 11/490,282

(22) Filed: Jul. 21, 2006

(51) Int. Cl. H02H 7/00

(52) U.S. Cl. 361/19

(57) ABSTRACT

Some recent experimental work (Pod,2001) implies that an electron cloud with external pulse from a superconductor(SC) can be generated at above approximately 500 kV. Also U.S. Pat. Nos. 593,138 and 4,661,747 imply that this can happen for nonSCs with rotating clouds of electrons above 500 kV. This can be done with a disk (θ=90) conducting rapid rotator ω (can be mechanical rotation or superconductor electron rotation) for pulse though V=512 kV (giving charge polar angle oscillation dθ/dt) which will experience a pulse according to:

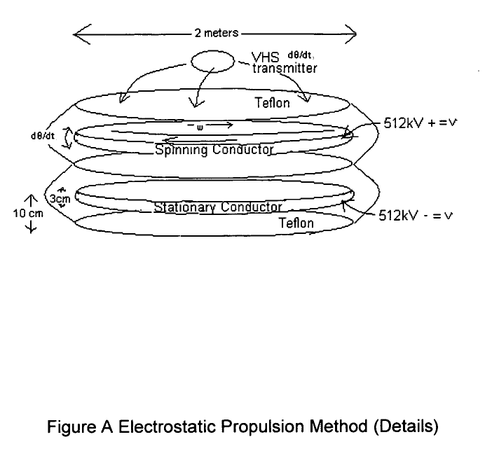

Impulse/m=k[∫[Vω(dθ/dtₒ)r sin² θ/(1−V/512 kV)]].

The device thus contains a w rotating (r large) disk so θ=90° in sin²θ, VHF oscillator for electron dθ/dtₒ, Voltage V near 512 kV in V.

### CROSS-REFERENCE TO RELATED APPLICATIONS

Not Applicable

### STATEMENT REGARDING FEDERALLY SPONSORED RESEARCH OR DEVELOPMENT

There was no Federally sponsored research or development involved in this patent.

### BACKGROUND OF THE INVENTION

Introduction

There is a unifying principle that also gives the correct physics: A new generalized Dirac equation

√g_{μμ}γ^{μ}∂ψ/∂χ_{μ}+iωψ=0 (1)

found by merely squaring the postulated invariant path ds=dsₜ+ds₁₀₀ + . . . (t=time, φ=azimuthal angle, recall ds²≡Σgᵢⱼdxⁱdx^{j}) and which has a new √gₒₒ coefficient which for spherical symmetry gₒₒ=1/gᵣᵣ and can be diagonalized This new metric coefficient is

gₒₒ=1−2e²/rmₑc²=1−r_{H}/r (2)

and replaces the covariance in the Dirac equation derivatives in the standard model (SM) with covariance in the metric that original Dirac equation is derived from. Note the equivalence principle is trivially obeyed with this gₒₒ if on some deep level there is only ONE mass mₑ of charge e and so implying such a E&M metric coefficient gᵢⱼ. There is extensive evidence that equation 1 is correct.

We next set up an artificial rotating metric using equation 2 metric inputs to find the time differential dt since (as we show later) cdt/dtₒ becomes our impulse. To find this dt we use our E&M ansatz

$${g}_{oo} = 1 - {c}^{2} 2 mr \text{/} {ρ}^{2} \approx 1 - \frac{2 eV ( x , t )}{2 {m}_{e} {c}^{2}}$$

the rotating metric

$${ds}^{2} = {ρ}^{2} ( \frac{{dr}^{2}}{Δ} + d {θ}^{2} ) + ( {r}^{2} + {a}^{2} ) {sin}^{2} θ d {φ}^{2} - {c}^{2} {dt}^{2} + \frac{2 mr}{{ρ}^{2}} {( a {sin}^{2} θ d θ - cdt )}^{2} \\ {ρ}^{2} ( r , θ ) ≡ {r}^{2} + {a}^{2} {cos}^{2} θ , Δ ( r ) ≡ {r}^{2} - 2 mr + {a}^{2} \qquad ( 3 )$$

### (Kerr metric) and solve for this dt by taking equation 3 to be a quadratic equation in dt using Ax²+Bx+C=0 where x≡dt here, given ρ≈r

$$B = \frac{2 mr}{{ρ}^{2}} a {sin}^{2} θ d θ \approx \frac{4 m}{r} a {sin}^{2} θ d θ ,$$

A=2mc/r−1, C=everything else. The solution is:

$$dt = \frac{- B \pm \sqrt{{B}^{2} - 4 AC}}{2 A} = \frac{- B}{2 A} \pm \sqrt{{( \frac{B}{2 A} )}^{2} - \frac{C}{A}} \qquad ( 4 )$$

### Note in the discriminant that for A=0 then 4AC=0. At θ≈0 C≈ds²≈−dr²+c²dt² and so for the commoving observer we can write for material moving along the z axis C=0 and dr=cdt and thus

dr/dtₒ≡vₑ₌cdt/dtₒ (5)

Using

$${g}_{00} \approx 1 - \frac{2 eV ( x , t )}{1 {m}_{e} {c}^{2}}$$

we use the electric potential V=ke/r=kQ/r for a point source where in mks k=9×10⁹ Jm/C, e=1.6×10⁻¹⁹ C for a electron charge, Q(=e) is the total charge. c²=3×10⁸ squared=9×10¹⁶ m²/s²: so: V=mₑc²/e=9.11×10⁻³¹(9×10¹⁶)/1.6×10⁻¹⁹=512 kV. Thus we rewrite equation 3 as m/r=V/512 kV: A=2mc/r−1=1−V/512 kV, normalized angular momentum a=(v/c)r=ωr then if V≈512 kV then from equation 4

dt≈−2B/2A=2(4(m/r)a sin² θdθ/[2(1−2mc/r)]=kVωrdθ sin² θdθ/[(1−V/512 kV)] (6)

Dividing both sides of equation 4 by dtₒ, the proper time interval and multiplying by c we find for the impulse:

Impulse/m=kV∫ωrdθ sin² θdθ/[(1−V/512 kV)] (7)

### BRIEF SUMMARY OF THE INVENTION

Multiplying equation 7 by c/dtₒ where dtₒ is the proper time we have:

Impulse/m=k[∫[Vw(dθ/dt)r sin² θ/(1−V/512 kV)]] 8)

If the voltage (V) is near 512 kV so that 1/(1−V/512 kV)=1/(1−512/512)=1/0 (equals infinity) was huge, if it is was rotating rapidly (ω) and in VHF so dθ/dt is large. Also sin² θ is largest on r radius disk such as a SC disk (sin 90=1). Then it could happen (just like in tornados or in Pod's rotating electrons in his superconductor) for this impulse to occur (that correct phasing could of course occur occasionally by chance) and so for this object to move vertically. That impulse provides the thrust. Hovering would be easy near 512 kV if you could also do the phasing on ω(θ/dt); very little power input required. Note by hovering you are not doing work and so not violating energy conservation. Give it a little excess power and it moves vertically. These devices could be no larger the cars are today, mass producable. You would have the basis for a revolutionary form of transportation.

Electrostatic 512 kV Rotator and/or Oscillator Propulsion System Electrostatic-Uses high voltage produced by electrostatic charge Generator.

512 kV−2mₑc²/2e=512,000 volts in the denominator of equation 1 Rotator—The rotation (that vr in equation 1) is provided by rotating capacitor plates or electrons in the vortices of a type II superconductor.

Oscillator—If just above 512 kV we must have non zero dθ/dt Oscillation provided by VHF source. For a ‘ramping’ voltage (from 0→3 MV lets say) this oscillation is not necessary.

Propulsion System—For the ramping voltage a mg (mostly repulsive) pulse is sent out. Use Newton's 3 law to get reaction, or propulsive, force. For voltage at a just above a steady 512 kV there is no propulsion but there is still annulment, hovering.

### BRIEF DESCRIPTION OF THE DRAWING

Figure A—Rotating Capacitors at just above 512 kV(details)

Impulse/m=k[∫[Vw(dθ/dt)r sin² θ/(1−V/512 kV)]] 9)

In equation 9 if on the upper disk the voltage (V) is near 512 kV so that 1/(1−V/512 kV)=1/(1−512/512)=1/0 (equals infinity) was huge, if it is was rotating rapidly (ω) and in VHF so dθ/dt is large then impulse/m in equation 9 is largest. Also sin² θ theta is largest on the upper r radius disk (sin 90=1) making equation 9 is largest as well. The lower disk does not rotate so that the net charge of both disks together is zero to the outside observer. The Teflon insulator keeps the charge on the conductors. According to equation 9 if dt is negative in impulse/m then a vertical impulse would occur.

### DETAILED DESCRIPTION OF THE INVENTION

We could build a prototype using this information gained. Rotating upper discs (or electrons at 512 kV moving rapidly in rotating insulated plates) will provide the propulsion. Energy is transferred from rotation to lift so that energy is conserved. The voltage at the lower weight spike (just above 512 kV) will be used for this purpose. According to equation 9 you can control the up or down force simply by controlling the voltage across rotating plates for which the voltage is just above 512 kV. This is that dθ/dt in equation 9 above provided by the VHF source. It is important that the oscillating field change in phase with the dθ/dt to keep the sign of the impulse term correct.

### RELATED PATENTS AND OTHER CONFIRMATIONAL EXPERIMENTAL RESULTS

U.S. Pat. No. 593,138 is for a type of transformer that above 400 kV (that voltage was recorded by later experimenters for this same apparatus) creates an “electro-radiant” event (cloud of electrons) that leaves perpendicular to the rotation direction of the current at above 400 kV. There is a accompanying “monodirectional repulsive impulse that penetrates all materials.” The inventor apparently did a lot of research verifying this result. Also U.S. Pat. No. 4,661,747 introduces a “conversion switching tube for inductive loads” that apparently created a similar pulse at a very high voltage. But note that our emphasis is on a static 512 kVrotator (with oscillation) that gives the mg lowering. This is not the same (pulse) concept as the previous two patents (but still uses equation 9) which merely give additional evidence that the device we are patenting is viable.

In addition here we propose these results as a theoretical explanation of a Russian experiment recently completed and published Aug. 3, 2001 (Pod, 2001). In the Russian experiment as the voltage went through ˜500 kV (in a type II superconductor[SC]) a positive and negative gravity pulse was created (recall the above diagram implies this also). The pulse was proportional to the magnetic field put on the superconductor so that it was proportional to the vortex velocity just as the above effect was proportional to the capacitor rotational velocity. The above equation 14, that gives these results, was presented in the February STAIF 2001 (Maker, STAIF2001). These experimental results were presented in Aug. 3, 2001. The gravity pulse was created by voltage on a superconducting disc. An electron cloud in the form of a disk (instead of a spark! Only sparks occurred below 500 kV) left the disc and moved rapidly to the anode in a low vacuum chamber. The gravity pulse itself left the chamber and was detected by pendulums (which moved) on the other side of the anode from the disk outside the chamber. The movement was independent of the mass of the pendulum implying that it was a “gravity” pulse. Unattenuated pulses (within measurement error) were detected at 100 m from the SC. U.S. Pat. No. 6,960,975) by Boris Volfson has two superconducting rotators but no physics behind it.

### DETAILED DESCRIPTION OF INVENTION STRUCTURES

Basically we have here a large cylindrical capacitor that can rotate rapidly and charged up to greater than 512 kV and hold the charge. The invention consists being able to use the 512 kV and rotation to get propulsion from this device. The components of this invention are a VHF radio wave source above the upper conductor for inducing dθ/dt charge motion inside the upper conductor. Lower conductor not spinning but charged to −512 kV by induction. Attached to the motor is gear reduction for very high speed wheel motion. 2 meter diameter, 1 centimeter thick, 2 centimeter high concave conductor (thinner in the middle) of 62 kg mass. This is the upper capacitor plate. 1.99 meter diameter, centimeter thick, 60 kg Teflon insulator over conductor cylinder (inside metal wheel). The lower conducting plate is charged to −512 kV and is not rotating. Wheel hub 10 cm diameter consisting of tandem inner and outer ball bearings and ball bearing mounts.

The idea here is to cause a rapid rotation of the rotator by turning on the motor. The rotation should be on the order of 1000 revs/sec. The voltage to 512 kV was created earlier by ion implanting creating an electret in the conductor inside the Teflon. The object will then have upward propulsion at a specific setting of the voltage near and just above 512 kV. If the voltage is lowered down to very near 512 kV the object will experience an upward propulsive force on it according to equation 7.

### REFERENCES

Bjorken, Drell, Relativistic Quantum Mechanics, McGraw-Hill, (1964).
Cottingham W. N., An Introduction to the Standard Model of Particle Physics, 1998, pp. 112.
Feynman, R. P., Quantum Electrodynamics, Benjamin, N.Y., (1961).
Goldstein, Herbert, Classical Mechanics, 2nd Ed, Addison Welsey, 1980 pp. 576.
Graves, J. C,. Brill, D. R., “Oscillating Character of an Ideal Charged Wormhole,” Phys. Rev 120 1507-17, (1962).
Halzen F, A. D. Martin, Quarks and Leptons, Wiley, (1984).
Hawking, S, Large Scale Structure of Space-Time, Cambridge University Press, (1973) pp. 169.
Kursunglu B. N. and A. P. Wigner, Reminiscences about a Great Physicist: P.A.M Dirac, Cambridge Univ. Press, Cambridge, (1987).
Liboff, Richard, Quantum Mechanics, 2nd ed., Addison-Wesley, (1991), pp. 202.
Maker, David, Quantum Physics and Fractal Space Time, Chaos, Solitons, Fractals, Vol. 10, No. 1, (1999).
Maker, David, “Propulsion Implications of a New Source for the Einstein Equations,” in proceedings of Space Technology and International Forum (STAIF 2001), edited by M. El-Genk, AIP Proceeding 552, AIP, NY, 2001, pp. 618-629.
Merzbacher, Quantum Mechanics, 2nd Edition, 1970 P. 596, equations 24.21, 24.24.
Podlkletnov, (Pod) arXiv:physics/o108005, 3 Aug. 2001.
Sokolnikof, Tensor Analysis, Wiley, (1964).
Weinberg, S., Relativity and Cosmology, Wiley, (1972).

1. A disk (θ=90) conducting rapid rotator ω (can be mechanical rotation or superconductor electron rotation) at just above V=512 kV in a low amplitude VHF electric field (giving charge polar angle oscillation dθ/dt) will experience continuous lower mg according to:
Impulse/m=k[integral[Vω(dθ/dt)r sin² θ/(1−V/512 kV)]].

2. A disk (θ=90) conducting rapid rotator ω (can be mechanical rotation or superconductor electron rotation) for pulse though V=512 kV (giving charge polar angle oscillation dθ/dt) will experience pulsed lower mg according to:
Impulse/m=k[integral[Vω(dθ/dt)r sin² θ/(1−V/512 kV)]].
